(19) United States
(12) Patent Application Publication
(10) Pub. No.: US 2019/0098676 A1
(43) Pub. Date: Mar. 28, 2019

(54) DIRECT RADIO INTERFACE

(71) Applicant: Intel Corporation, Santa Clara, CA (US)

(72) Inventor: Jonas Alexander Svennebring, Sollentuna (SE)

(73) Assignee: Intel Corporation, Santa Clara, CA (US)

(21) Appl. No.: 15/715,885

(22) Filed: Sep. 26, 2017

(51) Int. Cl. H04W 76/04; H04W 76/02

(52) U.S. Cl. CPC H04W 76/043; H04W 76/023; H04W 76/028; H04W 76/027; H04W 76/022

(57) ABSTRACT

Particular embodiments described herein provide for a system that can be configured to establish a communication path using a service provider's core infrastructure between a base station and a data center, where the service provider's core infrastructure includes one or more servicing gateways and one or more packet data network gateways, request a direct radio interface path be established as a new communication path between the base station and the data center, and establish the direct radio interface path between the base station and the data center, where the direct radio interface path bypasses the service provider's core infrastructure. In an example, the service provider's core infrastructure is part of a 3rd Generation Partnership Project (3GPP) network.

### BACKGROUND

The 3rd Generation Partnership Project (3GPP) is a collaboration between groups of telecommunications associations. The 3GPP standard encompasses radio access networks (RAN), telecommunications associations services and systems aspects, and core network and terminals. The 3GPP standard caters to a large majority of telecommunications networks and is the standard body behind Universal Mobile Telecommunications System (UMTS)/3G, Long-Term Evolution (LTE)/4G, and New Radio (NR)/5G. In 3GPP networks, the reduction of network latency has been of increased interest as bandwidths have risen.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a block diagram of a system to enable a direct radio interface, in accordance with an embodiment of the present disclosure;

FIG. 2 is a block diagram of a portion of a system to enable a direct radio interface, in accordance with an embodiment of the present disclosure;

FIG. 3 is a block diagram of example details to help enable a direct radio interface, in accordance with an embodiment of the present disclosure;

FIG. 4 is a block diagram of example details to help enable a direct radio interface, in accordance with an embodiment of the present disclosure;

FIG. 5 is a block diagram of example details to help enable a direct radio interface, in accordance with an embodiment of the present disclosure;

FIG. 6 is a block diagram of example details to help enable a direct radio interface, in accordance with an embodiment of the present disclosure;

FIG. 7 is a block diagram of example details to help enable a direct radio interface, in accordance with an embodiment of the present disclosure;

FIG. 8 is a flowchart illustrating potential operations that may be associated with the system in accordance with an embodiment; and

FIG. 9 is a flowchart illustrating potential operations that may be associated with the system in accordance with an embodiment.

The FIGURES of the drawings are not necessarily drawn to scale, as their dimensions can be varied considerably without departing from the scope of the present disclosure.

### DETAILED DESCRIPTION

### Example Embodiments

The following detailed description sets forth example embodiments of apparatuses, methods, and systems relating to a direct radio interface. Features such as structure(s), function(s), and/or characteristic(s), for example, are described with reference to one embodiment as a matter of convenience; various embodiments may be implemented with any suitable one or more of the described features.

In the following description, various aspects of the illustrative implementations will be described using terms commonly employed by those skilled in the art to convey the substance of their work to others skilled in the art. However, it will be apparent to those skilled in the art that the embodiments disclosed herein may be practiced with only some of the described aspects. For purposes of explanation, specific numbers, materials and configurations are set forth in order to provide a thorough understanding of the illustrative implementations. However, it will be apparent to one skilled in the art that the embodiments disclosed herein may be practiced without the specific details. In other instances, well-known features are omitted or to not obscure the illustrative implementations.

In the following detailed description, reference is made to the accompanying drawings that form a part hereof where like numerals designate like parts throughout, and in which is shown, by way of illustration, embodiments that may be practiced. It is to be understood that other embodiments may be utilized and structural or logical changes may be made without departing from the scope of the present disclosure. Therefore, the following detailed description is not to be taken in a limiting sense. For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C).

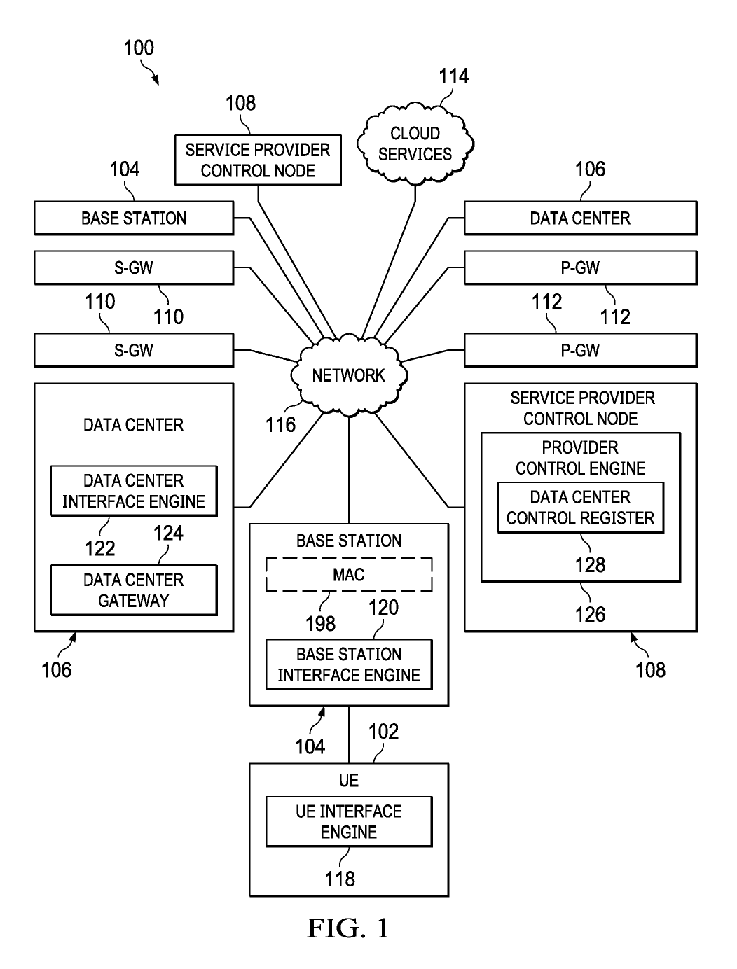

FIG. 1 is a block diagram of a system 100 to enable a direct radio interface, in accordance with an embodiment of the present disclosure. System 100 can include one or more user equipment (UE) 102, one or more base stations 104, one or more data centers 106, one or more service provider control nodes 108, one or more servicing gateways (S-GW) 110, one or more packet data network gateways (P-GW) 112, and cloud services 114. Base stations 104, data centers 106, service provider control nodes 108, S-GWs 110, P-GWs 112, and cloud services 114 can be in communication with each other using network 116. S-GW 110 and P-GW 112 can comprise a service provider's core infrastructure. The service provider's core infrastructure (e.g., Evolved Packet Core (EPC) in Long Term Evolution (LTE)/4G and New Radio (NR) in NR/5G) includes 3rd Generation Partnership Project (3GPP) architecture above the Layer-2 Media Access Control (MAC) sub-layer. For example, the service provider's core infrastructure can include one or more S-GWs (e.g., S-GW 110) and one or more P-GWs (e.g., P-GW 112). The layers and sub-layers above the Layer 2 MAC sub-layer are the Layer 2 radio link control (RLC) sub-layer, Layer 2 broadcast/multicast (BMC) sub-layer, Layer 2 packet data convergence protocol (PDCP) sub-layer, and Layer 3.

UE 102 can include a UE interface engine 118. Base station 104 can include a base station interface engine 120 and a MAC layer 198. Data center 106 can include a data center interface engine 122 and a data center gateway 124. Service provider control node 108 can include a provider control engine 126. Provider control engine 126 can include a data center control register 128.

Using UE interface engine 118, base station interface engine 120, data center interface engine 122, data center gateway 124, provider control engine 126, and data center control register 128, system 100 can be configured to establish a direct radio interface (DRI) between base station 104 and data center 106. For example, UE 102 can connect to base station 104 and base station 104 can be in communication with data center 106 over standard 3GPP using S-GW 110 and P-GW 112. A DRI connection can be requested either by data center interface engine 122 or UE interface engine 118. The DRI connection request is sent to service provider control node 108 and the DRI connection can be allowed by provider control engine 126. In an example, service provider control node 108 can be a serving general packet radio service support node. Data center control register 128 can be configured to include user data that will be used by provider control engine 126 to help determine if a DRI connection should be allowed, and if so, under what parameters. Once the DRI connection is established, base station 104 can communicate with data center 106 through the DRI connection and bypass the service provider's core infrastructure (e.g., S-GW 110 and P-GW 112). The term “DRI” includes an interface that allows an electronic device (e.g., a server) to communicate with a specific base station's air interface on a radio bearer level. The DRI connection targets specific base stations and specific radio bearers.

In an example, system 100 can be configured to establish a communication path using a service provider's core infrastructure and the service provider's radio access network (RAN) between a base station (e.g., base station 104) and a data center (e.g., data center 106), request a new DRI communication path be established as a new communication path between the base station and the data center, and establish the DRI communication path between the base station and the data center, where the DRI communication path bypasses the service provider's core infrastructure and/or the service provider's RAN. The service provider's core infrastructure can be part of a 3GPP network and include an S-GW (e.g., S-GW 110) and a P-GW (e.g., P-GW 112). In general, the term “core infrastructure” includes the functional communication facilities that interconnect primary nodes and delivery routes used to exchange information among various sub-networks. The term “core infrastructure” includes a network core, core network, and backbone network.

UE 102 can include mobile devices, personal digital assistants, smartphones, tablets, wearable technology, laptop computers, Internet of Things (IoT) devices, desktop computers, or other similar devices. Base station 104 can be a base transceiver station, cell site, base station, etc. that is configured to facilitate communications (e.g., wireless communication) between UE 102 and a network (e.g., network 116). Data center 106 can include one or more servers and/or one or more cloud networks. Data center 106 can be used to house computer systems and associated components, such as telecommunications and storage systems. S-GW 110 can forward user data packets, while also acting as a mobility anchor for the user plane during handovers (e.g., inter-eNodeB handovers) and as the anchor for mobility between LTE and other 3GPP technologies.

P-GW 112 can provide connectivity from UE 102 to external packet data networks by being a point of exit and entry of traffic for UE 102. UE 102 may have simultaneous connectivity with more than one P-GW for accessing multiple packet data networks (PDNs) and P-GW 112 may be referred to as a PDN gateway. P-GW 112 can be configured to perform policy enforcement, packet filtering, charging support, lawful interception, packet screening, etc. Another role of P-GW 112 can be to act as the anchor for mobility between 3GPP and non-3GPP technologies such as WiMAX, 3GPP2, Code Division Multiple Access (CDMA), 1 Times (or Single-Carrier) Radio Transmission Technology (1×RTT or X1), Evolution-Data Optimized (EvDO), etc. Service provider control node 108 can function as a serving general packet radio service support node (SGSN).

It is to be understood that other embodiments may be utilized and structural changes may be made without departing from the scope of the present disclosure. Substantial flexibility is provided by system 100 in that any suitable arrangements and configuration may be provided without departing from the teachings of the present disclosure.

For purposes of illustrating certain example techniques of system 100, it is important to understand the communications that may be traversing the network environment. The following foundational information may be viewed as a basis from which the present disclosure may be properly explained.

3GPP is a collaboration between groups of telecommunications associations. The initial scope of 3GPP was to establish a globally applicable third-generation (3G) mobile phone system specification based on an evolved global system for mobile communications (GSM). The scope was later broadened to include the development and maintenance of GSM and related 2G and 2.5G standards, including General Packet Radio Service (GPRS), GSM Evolution (EDGE), and Universal Mobile Telecommunications Service (UMTS). The scope of 3GPP was further broadened to include related 3G standards, including High Speed Packet Access (HSPA), LTE related 4G standards (including LTE Advanced and LTE Advanced Pro), next generation and related 5G standards, and an evolved IP Multimedia Subsystem (IMS) developed in an access independent manner. The 3GPP standard encompasses RAN, services and systems aspects, and core network and terminals. The 3GPP standard caters to a large majority of telecommunications networks and is the standard body behind UMTS, which is the 3G upgrade of GSM.

In 3GPP networks, the reduction of network latency has been of increased interest as bandwidths have risen from Wide Band Code Division Multiple Access (WCDMA)/3G to Long-Term Evolution (LTE)/4G to NR/5G. Current attempts to address network latency have mainly been though RAN/core network (CN) specifications (e.g., 3G direct tunneling) which allows for traffic to bypass an SGSN. SGSN was adopted in LTE with the split of mobility management entity (MME) (control) and S-GW/P-GW (data) and with the introduction of hybrid automatic repeat request (HARQ) in high speed downlink packet access (HSDPA) for 3G which allowed for a much faster reaction than using radio link control-acknowledgement mode (RLC-AM). Also, network equipment optimizations as well as operator network deployments (e.g., tougher through-node latency requirements, backhaul improvements, improving or shortening the distance from gateways to the Internet, etc.) have also been attempted to effect reductions in network latency. For 5G networks, initiatives such as mobile edge computing (MEC) and moving servers into the RAN itself (e.g., central offices) have also been attempted to reduce network latency. However, running services (e.g., virtualized in the RAN) are a concern for larger content providers which desire control of their execution environments, and such implementations have physical access concerns. An approach is needed that allows for a reduction of network latency, especially in a 3GPP-related network, while still allowing the content providers to be in control of their execution environments.

A system to enable a DRI, as outlined in FIG. 1 and herein, can resolve these issues (and others). System 100 can be configured to establish a DRI between a base station (e.g., base station 104) and a data center (e.g., data center 106). In an example, a UE (e.g., UE 102) connects to a data center, group of data centers, server, or group of servers, over standard 3GPP RAN/CN with appropriate security and authentication. A DRI connection is then requested. In an example, the DRI connection can be requested either by data center interface engine 122 or UE interface engine 118 and can be triggered automatically by an application or process. For example, an application or process may have an indicator or flag that triggers the DRI connection request after the UE is in communication with the data center. The DRI connection request is sent to service provider control node 108 and the DRI connection can be negotiated between the data center domain (e.g., data center interface engine 122) and the operator network domain (e.g., using provider control engine 126 and data center control register 128). This allows the content provider to be in control of its execution environment because the content provider can determine the parameters of the DRI connection. It also allows the service provider to maintain some control, as the DRI connection is not established unless the content provider allows for the establishment of the DRI connection and the service provider can request specific parameters for the DRI connection. Once confirmed, the DRI connection is established between the base station (e.g., base station 104) that is in communication with the UE and the data center domain through a dedicated radio bearer.

Radio bearers are channels offered by Layer-2 (in an OSI model) to higher layers for the transfer of either user or control data. Layer-2 provides the upper layers (e.g., Layers 3-7) transmission information by means of the radio bearer and signaling radio bearers. Typically, the radio bearer is between the base station and the UE and a server or data center is not aware of the radio bearer. System 100 can extend the radio bearer up to the data station (e.g., data center gateway 124) and the radio bearer service is part of the DRI connection and allows for a link between the base station and the data center, which is defined by a certain set of parameters (e.g., transport channel parameters, downlink physical channel parameters, uplink physical channel parameters, etc.) or characteristics (e.g., acknowledgment on packets received enabled or disabled, packet ordering handling enabled or disabled, buffering size, priority, error correction parameters, etc.). Whenever the UE is being provided with any service, the service is associated with a radio bearer specifying the configuration for Layer-2 and the Physical Layer in order to have its quality of service (QoS) clearly defined. The RAN (e.g., WCDMA RAN, LTE RAN, NR RAN, etc.) can provide radio access bearer connections between the base station and the data center with different parameters or characteristics in order to match requirements for different radio bearers. The signaling radio bearer can be used during connection establishment to establish the radio access bearer and to deliver signaling while on the connection (e.g., to perform a handover, reconfiguration or release, etc.).

Base station packet flow to the MAC layer (e.g. MAC layer 198) is similar to current implementations of base station packet flow. The DRI connection can communicate packets over a light-touch protocol (e.g., Ethernet+ virtual local area network (VLAN) with MAC indicating radio bearer and the VLAN for target data center domain selection). The packets are then routed to target servers for termination based on a radio bearer ID. Optional support for mobility is provided by a data center interface engine (e.g., data center interface engine 122) and a provider control node (e.g., service provider control node 108) together with currently existing nodes. Running services are not a concern for larger content providers as the data center domain is separated from the RAN/CN.

Compared to other current RAN/CN low latency implementations, the DRI connection to the data center can be at a low network level (e.g., Layer-2). The low network level can allow for an increased emphasis on data (from voice) and rapid growth in cloud networks, as well as the significant channel quality boost that 5G can bring. The DRI connection can also help enable low-latency services with sub-millisecond roundtrip requirements while leveraging the high bandwidth that 5G provides.

The DRI connection can provide a direct fast-path between the base station and the data center at the MAC layer (the lower sublayer of Layer-2 below the PCDP sub-layer, BMC sub-layer, and RLD sub-layer of Layer 2). In an example, the DRI connection can leverage a standard 3GPP connection for initialization and authentication. Once the connection to the data center is established, the DRI connection is opened for a dedicated radio bearer which is communicated from a baseband processing block just above the Layer-2 MAC layer. The radio bearer data can then be communicated across the DRI connection, which is a thin frame protocol (e.g., a low overhead encapsulation of data), into a data center gateway.

The DRI connection can be used in dense areas where high-bandwidth beamforming (or spatial filtering) 5G cells are primarily deployed and where the bulk of processing occurs in relatively few locations per area. In addition, the DRI connection can allow for a reduction in latency as well as decreasing the distance data travels between the data center domains and the base station by avoiding the service provider's RAN/CN without mixing or relocating the RAN/CN. Reducing latency can improve service quality and allow new types of services such as assistance to self-driving cars, industrial applications, IoT devices, etc. Decreasing the distance data travels between the data center and base station is a critical aspect not just to reduce latency but also to enable leveraging of high-throughput beamforming 5G cells due to notable asymmetry in air interface/backhaul behavior.

In an example, the DRI connection is based on a trusted collaboration or agreement between a content or cloud supplier (e.g., Google™, Microsoft Azure™, Amazon Web Services™, etc.) and a service provider (e.g., AT&T™, Vodafone™, etc.). The collaboration or agreement can be an extension of current collaborations or agreements between the content or cloud supplier and the service provider and can help define when the service provider will allow the DRI connection (e.g., the service provider can request specific parameters or characteristics for the DRI connection). The DRI connection can help remove many of the latency issues in current RAN/CNs. Also, the DRI connection can allow for a fast connection between UEs and selected cloud/content providers. Furthermore, the DRI connection can allow for significantly lower end-to-end latency since much larger portions of the 3GPP nodes and stack are bypassed. In addition, the DRI connection can allow the endpoints to decide themselves what characteristics/overhead the connection should have and therefore improve the DRI connection on a per-use-case basis. The DRI connection can allow for a continued separation between the service provider controlled RAN/CN and the cloud/content provider's data center, which generally is a requirement for some service providers.

By removing latency driving services (complex networking functions that control packet ordering and manage the flows, radio link control (RLC) acknowledgement/no-acknowledgement (ack/nack) handling/buffering, IPsec and air crypto, etc.) as well as the service provider's core infrastructure (e.g., most of the RAN/CN architecture including the S-GW and P-GW with associated stacks, aggregation node for split RAN, etc.) for packets on the DRI connection path, it is possible to substantially reduce the latency primarily by removing time spent in queues and buffers, handover mechanisms, raw compute cycles of nonessential functions, etc. Additionally, optional services such as encryption or ciphering, packet ordering, reliability, large packets, etc. can also be provided to the endpoints (e.g., UE 102 and data center 106) through an enablement library. These functions can be mixed and matched to allow for the endpoints to communicate with relatively minimal overhead provided by the lower layers. Mobility usage, such as handover, between baseband units belonging to the same central office could be efficiently handled as the DRI connection to the data center will be the same (same data center gateway 124 ID and same base station 104 ID). In the case of handover between nodes belonging to different central offices, a negotiation would be needed and, depending on deployment and how the data center handles its different services, a data center service migration could also be triggered.

Elements of FIG. 1 may be coupled to one another through one or more interfaces employing any suitable connections (wired or wireless), which provide viable pathways for network (e.g., network 116, etc.) communications. Additionally, any one or more of these elements of FIG. 1 may be combined or removed from the architecture based on particular configuration needs. System 100 may include a configuration capable of transmission control protocol/Internet protocol (TCP/IP) communications for the transmission or reception of packets in a network. System 100 may also operate in conjunction with a user datagram protocol/IP (UDP/IP) or any other suitable protocol where appropriate and based on particular needs.

Turning to the infrastructure of FIG. 1, system 100 in accordance with an example embodiment is shown. Generally, system 100 may be implemented in any type or topology of networks. Network 116 represents a series of points or nodes of interconnected communication paths for receiving and transmitting packets of information that propagate through system 100. Network 116 offers a communicative interface between nodes and may be configured as any local area network (LAN), VLAN, wide area network (WAN), wireless local area network (WLAN), metropolitan area network (MAN), Intranet, Extranet, virtual private network (VPN), and any other appropriate architecture or system that facilitates communications in a network environment, or any suitable combination thereof, including wired and/or wireless communication. Cloud services 114 may generally be defined as the use of computing resources that are delivered as a service over a network, such as the Internet. Using cloud services 114, compute, storage, and network resources can be offered in a cloud infrastructure, effectively shifting the workload from a local network to the cloud network.

In system 100, network traffic, which is inclusive of packets, frames, signals, data, etc., can be sent and received according to any suitable communication messaging protocols. Suitable communication messaging protocols can include a multi-layered scheme such as the Open Systems Interconnection (OSI) model, or any derivations or variants thereof (e.g., TCP/IP and UDP/IP, by way of nonlimiting example). Additionally, radio signal communications over a cellular network may also be provided in system 100. Suitable interfaces and infrastructure may be provided to enable communication with the cellular network.

The term “packet,” as used herein, refers to a unit of data that can be routed between a source node and a destination node on a packet switched network. A packet includes a source network address and a destination network address. These network addresses can be IP addresses in a TCP/IP messaging protocol. The term “data,” as used herein, refers to any type of binary, numeric, voice, video, textual, or script data, or any type of source or object code, or any other suitable information in any appropriate format that may be communicated from one point to another in electronic devices and/or networks.

In an example implementation, base station 104, data center 106, S-GW 110, P-GW 112, and service provider control node 108 are meant to encompass network appliances, servers, routers, switches, gateways, bridges, load balancers, processors, modules, or any other suitable device, component, element, or object operable to exchange information in a network environment. Base station 104, data center 106, S-GW 110, P-GW 112, and service provider control node 108 may include any suitable hardware, software, components, modules, or objects that facilitate the operations thereof, as well as suitable interfaces for receiving, transmitting, and/or otherwise communicating data or information in a network environment. This may be inclusive of appropriate algorithms and communication protocols that allow for the effective exchange of data or information. Each of base station 104, data center 106, S-GW 110, P-GW 112, and service provider control node 108 may be virtual or include virtual elements.

In regard to the internal structure associated with system 100, each of base station 104, data center 106, S-GW 110, P-GW 112, and service provider control node 108 can include memory elements for storing information to be used in the operations outlined herein. Each of base station 104, data center 106, S-GW 110, P-GW 112, and service provider control node 108 may keep information in any suitable memory element (e.g., random access memory (RAM), read-only memory (ROM), erasable programmable ROM (EPROM), electrically erasable programmable ROM (EEPROM), application specific integrated circuit (ASIC), etc.), software, hardware, firmware, or in any other suitable component, device, element, or object where appropriate and based on particular needs. Any of the memory items discussed herein should be construed as being encompassed within the broad term ‘memory element.’ Moreover, the information being used, tracked, sent, or received in system 100 could be provided in any database, register, queue, table, cache, control list, or other storage structure, all of which can be referenced within any suitable timeframe. Any such storage options may also be included within the broad term ‘memory element’ as used herein.

In certain example implementations, the functions outlined herein may be implemented by logic encoded in one or more tangible media (e.g., embedded logic provided in an ASIC, digital signal processor (DSP) instructions, software (potentially inclusive of object code and source code) to be executed by a processor, or other similar machine, etc.), which may be inclusive of non-transitory computer-readable media. In some of these instances, memory elements can store data used for the operations described herein. This includes the memory elements being able to store software, logic, code, or processor instructions that are executed to carry out the activities described herein.

In an example implementation, elements of system 100, such as base station 104, data center 106, S-GW 110, P-GW 112, and service provider control node 108 may include software modules (e.g., UE interface engine 118, base station interface engine 120, data center interface engine 122, data center gateway 124, provider control engine 126, etc.) to achieve, or to foster, operations as outlined herein. These modules may be suitably combined in any appropriate manner, which may be based on particular configuration and/or provisioning needs. In example embodiments, such operations may be carried out by hardware, implemented externally to these elements, or included in some other network device to achieve the intended functionality. Furthermore, the modules can be implemented as software, hardware, firmware, or any suitable combination thereof. These elements may also include software (or reciprocating software) that can coordinate with other network elements in order to achieve the operations as outlined herein.

Additionally, each of base station 104, data center 106, S-GW 110, P-GW 112, and service provider control node 108 may include a processor (or core of a processor) that can execute software or an algorithm to perform activities as discussed herein. A processor can execute any type of instructions associated with the data to achieve the operations detailed herein. In one example, the processors could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an erasable programmable read-only memory (EPROM), an electrically erasable programmable read-only memory (EEPROM) or an ASIC that includes digital logic, software, code, or electronic instructions), or any suitable combination thereof. Any of the potential processing elements, modules, and machines described herein should be construed as being encompassed within the broad term ‘processor.’

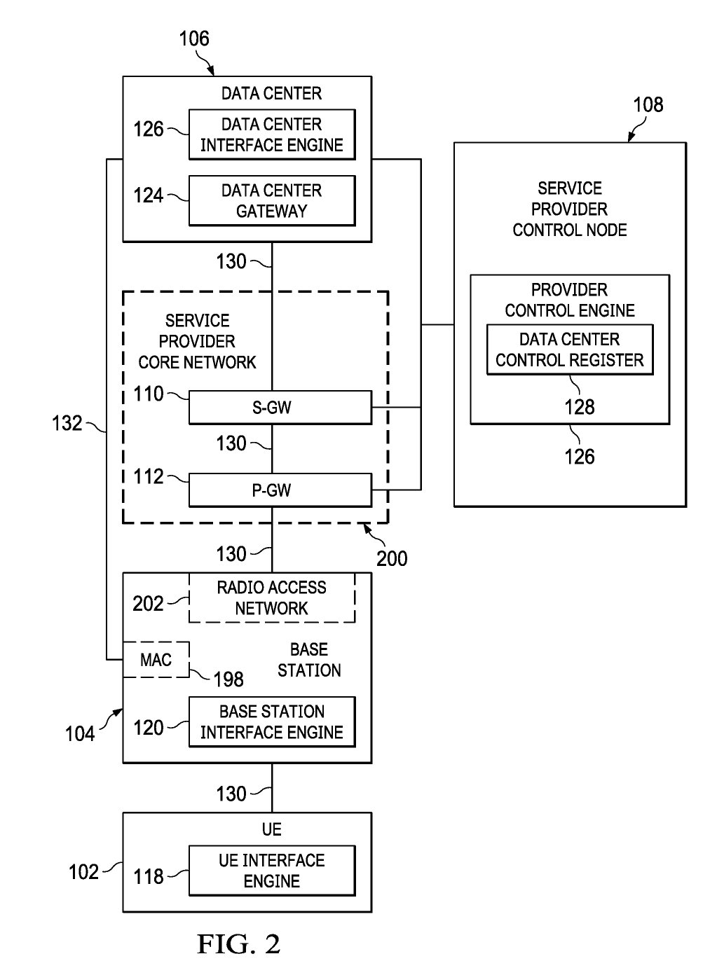

Turning to FIG. 2, FIG. 2 is a block diagram of a portion of a system 100, in accordance with an embodiment of the present disclosure. As illustrated in FIG. 2, UE 102 can connect to a data center 106 using a service provider's communication path 130 through the service provider's core infrastructure 200 and the service provider's RAN 202. In an example, service provider's core infrastructure 200 is created using 3GPP and includes a service provider's network (e.g., S-GW 110, P-GW 112, etc.). Service provider's RAN 202 can be part of the service provider's communication system and implements radio access technology to facilitate communications on the service provider's core infrastructure 200. Service provider's RAN 202 can be centralized in base station 104 or distributed across two or more base stations.

After communication between UE 102 and data center 106 using the service provider's core infrastructure 200 is established, a DRI communication path 132 can be requested, and if approved, established. DRI communication path 132 does not need to be merged with the service provider's core infrastructure 200 and could be established as a separate proprietary communication path. DRI communication path 132 can provide a network path directly between base station 104 and data center 106 and once DRI communication path 132 has been established, the service provider's core infrastructure 200 and the service provider's RAN 202 can be bypassed. In a specific example, if the service provider's core infrastructure 200 is created using 3GPP, then the 3GPP architecture above the MAC layer can be bypassed. In an example, service provider's communication path 130 can remain active and DRI communication path 132 can be established on top of the service provider's core infrastructure 200 (e.g., current 3GPP-based RAN/CN architecture targeting NR/5G deployment).

Once DRI communication path 132 is established, a radio bearer is established between UE interface engine 118 and data center gateway 124. The MAC layer packets (PDUs) for the radio bearer are directed from the MAC layer directly over DRI communication path 132 to data center 106. Because a DRI connection interfaces at a very low level, it is generally unaffected by or can easily be adopted to changes such as split RAN.

Using a Radio Resource Control (RRC) protocol, data center interface engine 122 can be configured to identify a new radio bearer as a DRI bearer. The RRC protocol is used in UMTS and LTE on an air interface and can exist between UE 102 and base station 104 at the IP level. The RRC protocol is specified by 3GPP and the major functions of the RRC protocol include connection establishment and release functions, broadcast of system information, radio bearer establishment, reconfiguration and release, RRC connection mobility procedures, paging notification, and release and outer loop power control. By means of signaling functions, the RRC protocol can be used to configure the user and control planes according to the network status and allow for radio resource management strategies to be implemented by base station interface engine 120.

Base station interface engine 120 can leverage an RRC session from UE 102 and allocate a logic channel identifier (LCID) for packets being communicated on DRI communication path 132. The DRI radio bearer would then not be known outside of base station 104. The RRC session could avoid setting up protocol layers for the radio bearer such as Packet Data Convergence Protocol (PDCP) or alternatively keep an “empty” placeholder for the radio bearer in the protocol layers. Other approaches such as keeping the set up for the service provider's core infrastructure 200 and establishing and marking the evolved packet system (EPS) bearer ID or evolved universal terrestrial radio access network (E-UTRAN) radio access bearer (E-RAB) could be implemented. However, those would then also be allocated in legacy 3GPP nodes.

It should be noted that DRI communication path 132 can be used as a fast path connection in an MEC deployment. Also, although DRI communication path 132 bypasses large portions of the service provider's core infrastructure 200 (e.g., the 3GPP nodes/stack), DRI communication path 132 can allow for essential functions such as authentication, data encryption, handover, charging, etc. (although not necessarily handled in the same manner as current implementations). In an example, the essential functions can be communicated over service provider's communication path 130 if service provider's communication path 130 remains active. Encryption or ciphering can be entirely pushed to the endpoints (e.g., UE 102 and data center 106) where it can be adapted to the applications as needed but can also ensure that no service provider tampers with the data. Non-essential functions such as packet ordering handling and delivery notification can also be handled by the endpoints.

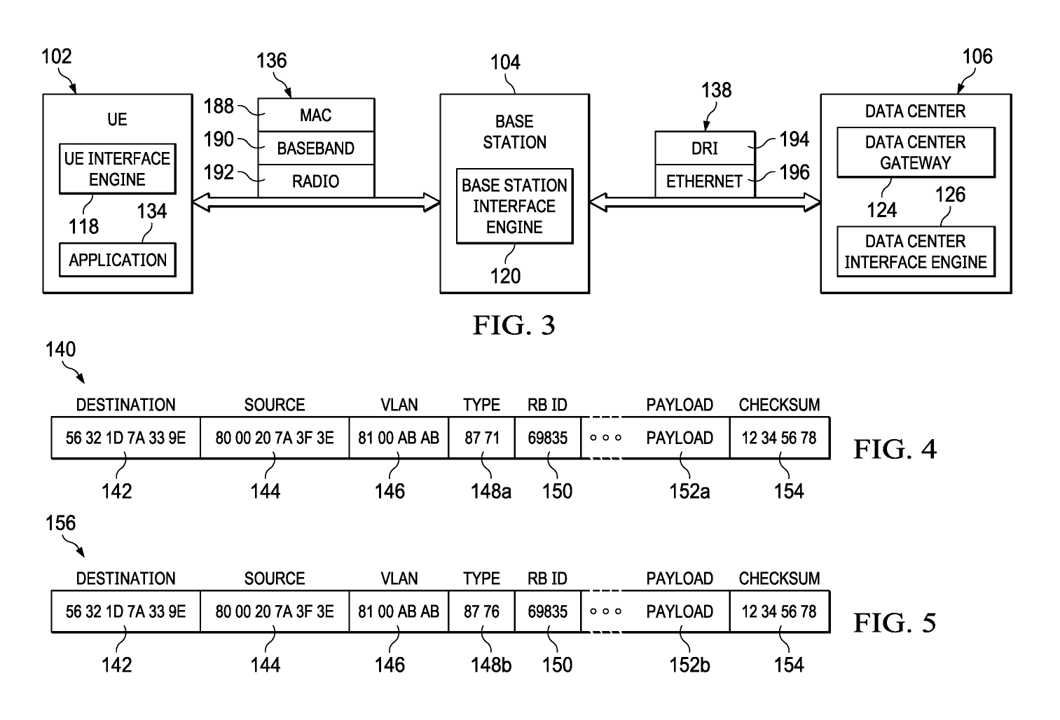

Turning to FIG. 3, FIG. 3 is a block diagram of a portion of system 100, in accordance with an embodiment of the present disclosure. As illustrated in FIG. 3, DRI communication path 132 has been established between base station 104 and data center 106. UE 102 can include an application 134 and application 134 can request data from data center 106. The data request from application 134 can be received by UE interface engine 118. UE interface engine 118 can generate a UE/base station DRI packet 136. UE/base station DRI packet 136 can include MAC data 188, baseband data 190, and radio data 192. Base station interface engine 120 can receive UE/base station DRI packet 136, and in response, communicate a base station/data center DRI packet 138 to data center 106. Base station/data center DRI packet 138 can include DRI data 194 and Ethernet data 196. Data center interface engine 122 and/or data center gateway 124 can receive base station/data center DRI packet 138, and communicate a response back to base station 104 using base station/data center DRI packet 138. Base station 104 can forward the response to UE 102 using UE/base station DRI packet 136.

MAC data 188 can include mapping to logical channels, sequence number, packet size, information to be transferred, etc. Baseband data 190 can include coded and modulated information. Radio data 192 can include information transferred wirelessly over a wireless connection. DRI data 194 can be associated with radio bearer data as well as other information to be transferred. Ethernet data 196 can include source and destination MAC address, higher layer protocol type, and packet checksum as well as other information to be transferred.

The raw stack for the DRI connection only includes a minimal set of functionalities to transmit PDUs from the MAC layer. Base station interface engine 120 can be configured to use MAC PDUs along with metadata in an Ethernet frame or jumbo Ethernet frame with a MAC address set to a radio bearer ID and a VLAN set to data center gateway 124 and then into data center 106. It should be noted that alternative framing implementations can also be used. Data center gateway 124 can be configured for protocol conversion and an ID check between DRI and data center transport. Data center gateway 124 can also be configured to handle optional functions such as statistics and charging, local breakout for debug, and lawful interception.

The MAC layer remains unchanged with the DRI connection. In an example, data can flow to/from UE 102, through the RLC, MAC layer, and physical layer of base station 104, and to/from data center 106. By leveraging the HARQ flow in MAC, it is possible to handle most packet retransmissions efficiently. However, higher level (e.g., RLC-acknowledged mode (AM)) functions such as retransmission and reordering are not supported in favor of lower latency and lower complexity. The endpoints can be configured to apply appropriate functions to give as robust a network service as required for specific usage.

Turning to FIG. 4, FIG. 4 is a block diagram illustrating example details of a DRI data frame 140, in accordance with an embodiment. In an example, DRI data frame 140 can include a destination portion 142, a source portion 144, a VLAN portion 146, a type portion 148a, a radio bearer ID portion 150, a payload portion 152a, and a checksum portion 154. DRI data frame 140 can be part of data communicated to or from data center gateway 124.

Destination portion 142 can include a destination MAC address for DRI data frame 140. Source portion 144 can include a source MAC address for DRI data frame 140. VLAN portion 146 can include data for either intra-data center usage (different customers) to differentiate between data centers of the same owner or between data centers with different owners (e.g., a data center owned by Google™, a data center owned by Amazon™, etc.). The data in VLAN portion 146 can be deployment specific and can help ensure that packets from base station 104 are routed to the correct data center. Type portion 148a can include the type of packet associated with DRI data frame 140. For example, type portion 148a illustrated in FIG. 4 can indicate that DRI data frame 140 is a data frame. Radio bearer ID portion 150 can include data related to the radio bearer associated with UE 102. Payload portion 152a can include the payload of DRI data frame 140. For example, because DRI data frame 140 is a data frame, payload portion 152a can include application data. Checksum portion 154 can include checksum data for DRI data frame 140.

Turning to FIG. 5, FIG. 5 is a block diagram illustrating example details of a DRI control frame 156, in accordance with an embodiment. In an example, DRI control frame 156 can include destination portion 142, source portion 144, VLAN portion 146, a type portion 148b, a radio bearer ID portion 150, a payload portion 152b, and a checksum portion 154. DRI control frame 156 can be part of control data communicated to or from data center gateway 124.

Type portion 148b can include the type of packet associated with DRI control frame 156. For example, type portion 148b illustrated in FIG. 5 can indicate that DRI control frame 156 is a control frame. Payload portion 152b can include the payload of DRI control frame 156. For example, because DRI control frame 156 is a control frame, payload portion 152b can include control data.

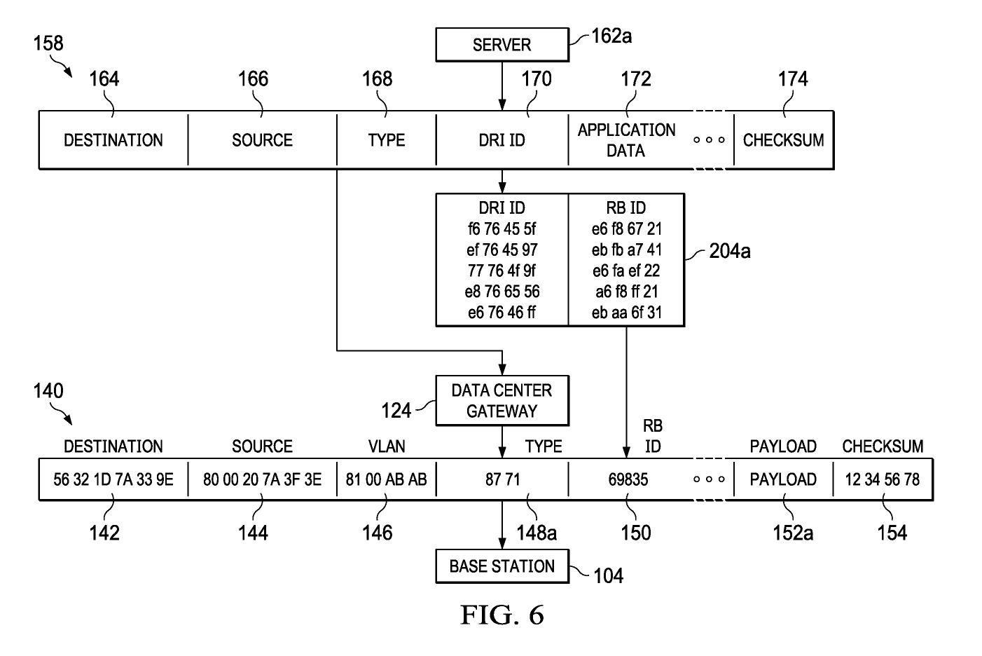

Turning to FIG. 6, FIG. 6 is a block diagram illustrating example details of DRI routing, in accordance with an embodiment. In an example, a server 162a can communicate an Ethernet DRI packet 158 to data center gateway 124. Ethernet DRI packet 158 can include a destination portion 164, a source portion 166, a type portion 168, a DRI ID portion 170, an application data portion 172, and a checksum portion 174.

Destination portion 164 can include a destination identifier for Ethernet DRI packet 158. Source portion 166 can include a source identifier for Ethernet DRI packet 158. Type portion 168 can include a type identifier for Ethernet DRI packet 158. DRI ID portion 170 can include an identifier (e.g., a server's Ethernet address) of the source associated with Ethernet DRI packet 158. Application data portion 172 can include the payload of Ethernet DRI packet 158. A checksum portion 174 can include checksum data.

In response to receiving Ethernet DRI packet 158, data center gateway 124 can communicate a data center gateway/base station packet (e.g., DRI data frame 140) to base station 104. The data in DRI ID portion 170 can be used to propagate the data in radio bearer ID portion 150. For example, a DRI translation table 204a can be used to translate a DRI ID from DRI ID portion 170 into a radio bearer ID in radio bearer ID portion 150 in one direction and to translate a radio bearer ID from radio bearer ID portion 150 into a DRI ID in DRI ID portion 170.

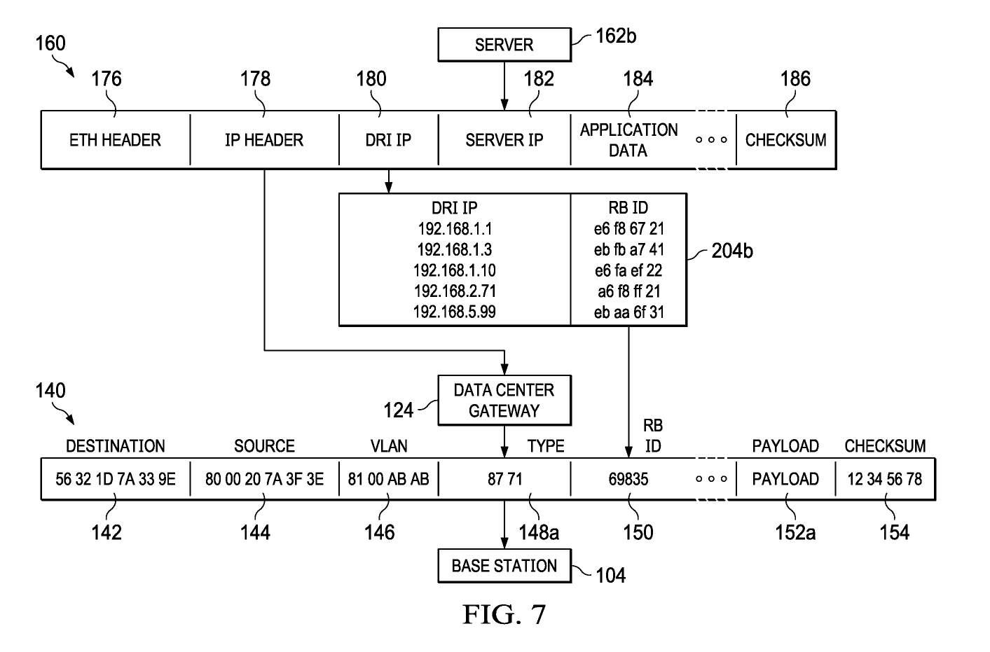

Turning to FIG. 7, FIG. 7 is a block diagram illustrating example details of DRI routing, in accordance with an embodiment. In an example, a server 162b can communicate an IP DRI packet 160 to data center gateway 124. IP DRI packet 160 can include an Ethernet header portion 176, an IP header portion 178, a DRI IP 180, a server IP 182, an application data portion 184, and a checksum portion 186. As illustrated in FIG. 6, a table can be

Ethernet header portion 176 can include an Ethernet header for IP DRI packet 160. IP header portion 178 can include an IP header for IP DRI packet 160. DRI IP 180 can include an IP address for the source of IP DRI packet 160. Server IP 182 can include an IP address for the server that will receive IP DRI packet 160. Application data portion 184 can include the payload of IP DRI packet 160. Checksum portion 186 can include checksum data.

In response to receiving IP DRI packet 160, data center gateway 124 can communicate a data center gateway/base station packet (e.g., DRI data frame 140) to base station 104. The data in DRI IP 180 can be used to propagate the data in radio bearer ID portion 150. For example, a DRI translation table 204b can be used to translate a DRI IP from DRI IP portion 180 into a radio bearer ID in radio bearer ID portion 150 in one direction and to translate a radio bearer ID from radio bearer ID portion 150 into a DRI IP in DRI IP portion 180.

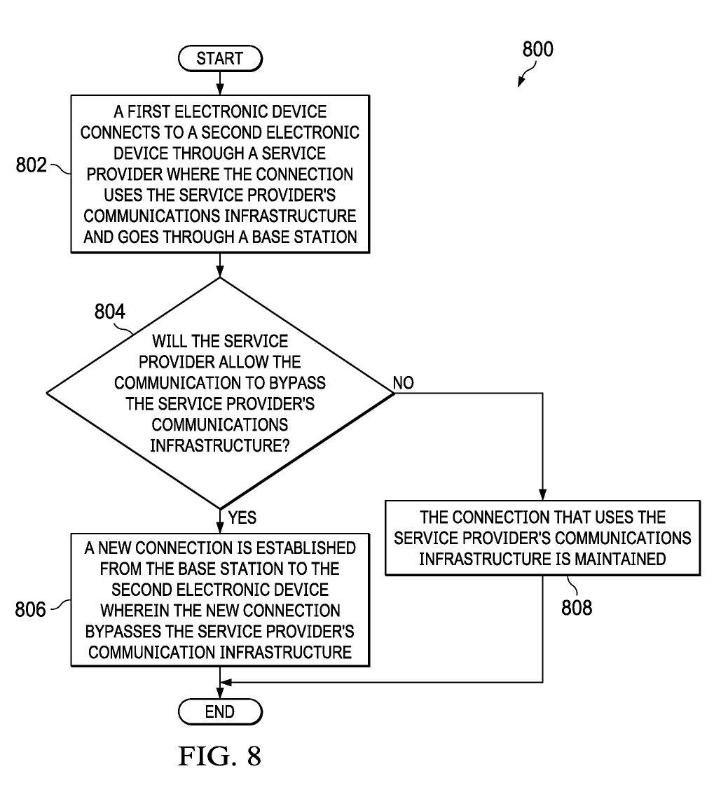

Turning to FIG. 8, FIG. 8 is an example flowchart illustrating possible operations of a flow 800 that may be associated with a DRI, in accordance with an embodiment. In an embodiment, one or more operations of flow 800 may be performed by UE interface engine 118, base station interface engine 120, data center interface engine 122, data center gateway 124, and/or provider control engine 126. At 802, a first electronic device connects to a second electronic device through a service provider, where the connection uses the service provider's communications infrastructure and passes through a base station. At 804, the system determines if the service provider will allow the communication to bypass the service provider's communications infrastructure. If the service provider will allow the communication to bypass the service provider's communications infrastructure, then a new connection is established from the base station to the second electronic device, where the new connection bypasses the service provider's communication infrastructure, as in 806. If the service provider will not allow the communication to bypass the service provider's communications infrastructure, then the connection that uses the service provider's communications infrastructure is maintained.

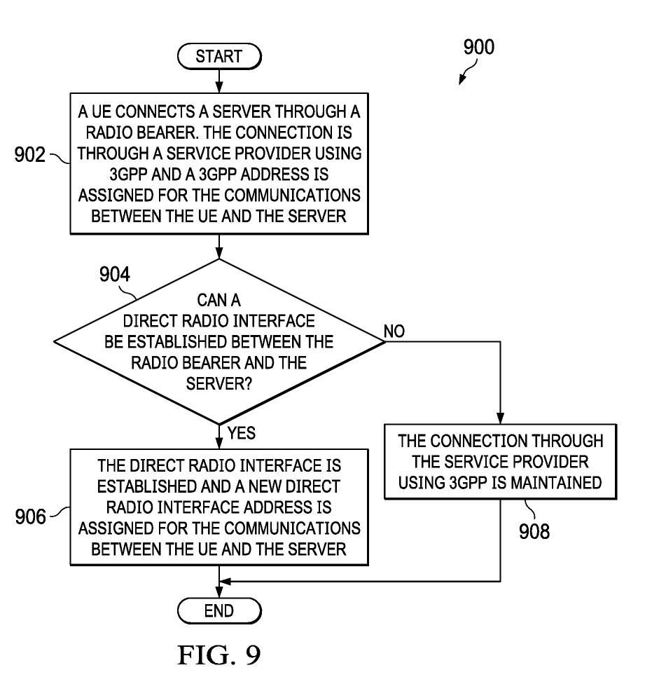

Turning to FIG. 9, FIG. 9 is an example flowchart illustrating possible operations of a flow 900 that may be associated with a DRI, in accordance with an embodiment. In an embodiment, one or more operations of flow 900 may be performed by UE interface engine 118, base station interface engine 120, data center interface engine 122, data center gateway 124, and/or provider control engine 126. At 902, a UE connects to a server through a radio bearer. The connection is through a service provider using 3GPP and a 3GPP address is assigned for communications between the UE and the server. At 904, the system determines if a DRI connection can be established between the radio bearer and the server. If a DRI connection can be established between the radio bearer and the server, then the DRI connection is established and a DRI address is assigned for communications between the UE and the server, as in 906. If a DRI connection cannot be established between the radio bearer and the server, the connection through the service provider using 3GPP is maintained.

Note that with the examples provided herein, interaction may be described in terms of two, three, or more network elements. However, these embodiments are for purposes of clarity and example only, and are not intended to be limiting. In certain cases, it may be easier to describe one or more of the functionalities of a given set of flows by only referencing a limited number of network elements. It should be appreciated that system 100 and its teachings are readily scalable and can accommodate a large number of components, as well as more complicated/sophisticated arrangements and configurations. Accordingly, the examples provided should not limit the scope or inhibit the broad teachings of system 100 as potentially applied to a myriad of other architectures.

It is also important to note that the operations in the preceding flow diagrams (i.e., FIGS. 8 and 9) illustrate only some of the possible correlating scenarios and patterns that may be executed by, or within, system 100. Some of these operations may be deleted or removed where appropriate, or these operations may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by system 100 in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. Moreover, certain components may be combined, separated, eliminated, or added based on particular needs and implementations. Additionally, although system 100 has been illustrated with reference to particular elements and operations that facilitate the communication process, these elements and operations may be replaced by any suitable architecture, protocols, and/or processes that achieve the intended functionality of system 100.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

### OTHER NOTES AND EXAMPLES

Example C1 is at least one machine readable storage medium having one or more instructions that when executed by at least one processor, cause the at least one processor to establish a communication path using a service provider's core infrastructure between a base station and a data center, where the service provider's core infrastructure includes one or more servicing gateways and one or more packet data network gateways, request a direct radio interface path be established as a new communication path between the base station and the data center, and establish the direct radio interface path between the base station and the data center, where the direct radio interface path bypasses the service provider's core infrastructure.

In Example C2, the subject matter of Example C1 can optionally include where the service provider's core infrastructure is part of a 3rd Generation Partnership Project (3GPP) network.

In Example C3, the subject matter of any one of Examples C1-C2 can optionally include where the bypassed service provider's core infrastructure includes 3GPP architecture above a Layer 2 media access control sub-layer.

In Example C4, the subject matter of any one of Examples C1-C3 can optionally include where the direct radio interface path to the data center is at a Layer 2 network level.

In Example C5, the subject matter of any one of Examples C1-C4 can optionally include where a media access control layer remains unchanged when the direct radio interface path is established.

In Example C6, the subject matter of any one of Examples C1-05 can optionally include where the communication path using the service provider's core infrastructure is maintained when the direct radio interface path is established.

In Example C7, the subject matter of any one of Examples C1-C6 can optionally include where the request that the direct radio interface path be established is communicated to a service provider control node associated with the service provider.

In Example C8, the subject matter of any one of Examples C1-C7 can optionally include where a user equipment associated with the base station requests the direct radio interface path be established and the request is communicated to a service provider control node from the base station.

In Example A1, a server in a data center can include memory, a data center interface engine, and at least one processor. The data center interface engine is configured to cause the at least one processor to communicate on a communication path using a service provider's core infrastructure between a base station and the data center, where the service provider's core infrastructure includes one or more servicing gateways and one or more packet data network gateways, request a direct radio interface path be established as a new communication path between the base station and the data center, and establish the direct radio interface path between the base station and the data center, where the direct radio interface path bypasses the service provider's core infrastructure.

In Example A2, the subject matter of Example A1 can optionally include where the service provider's core infrastructure is part of a 3rd Generation Partnership Project (3GPP) network.

In Example A3, the subject matter of any one of Examples A1-A2 can optionally include where the bypassed service provider's core infrastructure includes 3GPP architecture above a Layer 2 media access control sub-layer.

In Example A4, the subject matter of any one of Examples A1-A3 can optionally include where the direct radio interface path to the data center is at a Layer 2 network level.

In Example A5, the subject matter of any one of Examples A1-A4 can optionally include where a media access control layer remains unchanged when the direct radio interface path is established.

Example M1 is a method including establishing a communication path using a service provider's core infrastructure between a base station and at least one server, where the service provider's core infrastructure includes one or more servicing gateways and one or more packet data network gateways, requesting a direct radio interface path be established as a new communication path between the base station and the at least one server, and establishing the direct radio interface path between the base station and the at least one server, where the direct radio interface path bypasses the service provider's core infrastructure.

In Example M2, the subject matter of Example M1 can optionally include where the service provider's core infrastructure is part of a 3rd Generation Partnership Project (3GPP) network.

In Example M3, the subject matter of any one of the Examples M1-M2 can optionally include where the bypassed service provider's core infrastructure includes 3GPP architecture above a Layer 2 media access control sub-layer.

In Example M4, the subject matter of any one of the Examples M1-M3 can optionally include where the direct radio interface path to the at least one server is at a Layer 2 network level.

In Example M5, the subject matter of any one of the Examples M1-M4 can optionally include where a media access control layer remains unchanged when the direct radio interface path is established.

In Example M6, the subject matter of any one of Examples M1-M5 can optionally include where the communication path using the service provider's core infrastructure is maintained when the direct radio interface path is established.

Example S1 is a system for establishing a direct radio interface connection. The system can include memory, one or more processors, means for establishing a communication path using a service provider's core infrastructure between a base station and at least one server, where the service provider's core infrastructure includes one or more servicing gateways and one or more packet data network gateways, means for requesting a direct radio interface path be established as a new communication path between the base station and the at least one server, and means for establishing the direct radio interface path between the base station and the at least one server, where the direct radio interface path bypasses the service provider's core infrastructure.

In Example S2, the subject matter of Example S1 can optionally include where the service provider's core infrastructure is part of a 3rd Generation Partnership Project (3GPP) network.

In Example S3, the subject matter of any one of the Examples S1-S2 can optionally include where the direct radio interface path to the at least one server is at a Layer 2 network level.

In Example S4, the subject matter of any one of the Examples S1-S3 can optionally include where a media access control layer remains unchanged when the direct radio interface path is established.

In Example S5, the subject matter of any one of the Examples S1-S4 can optionally include where the communication path using the service provider's core infrastructure is maintained when the direct radio interface path is established.

In Example S6, the subject matter of any one of the Examples S1-S5 can optionally include where the request that the direct radio interface path be established is communicated to a service provider control node associated with the service provider.

Example AA1 is an apparatus including means for establishing a communication path using a service provider's core infrastructure between a base station and a data center, where the service provider's core infrastructure includes one or more servicing gateways and one or more packet data network gateways, means for requesting a direct radio interface path be established as a new communication path between the base station and the data center, and means for establishing the direct radio interface path between the base station and the data center, where the direct radio interface path bypasses the service provider's core infrastructure.

In Example AA2, the subject matter of Example AA1 can optionally include where the service provider's core infrastructure is part of a 3rd Generation Partnership Project (3GPP) network.

In Example AA3, the subject matter of any one of Examples AA1-AA2 can optionally include where the bypassed service provider's core infrastructure includes 3GPP architecture above a Layer 2 media access control sub-layer.

In Example AA4, the subject matter of any one of Examples AA1-AA3 can optionally include where the direct radio interface path to the data center is at a Layer 2 network level.

In Example AA5, the subject matter of any one of Examples AA1-AA4 can optionally include where a media access control layer remains unchanged when the direct radio interface path is established.

In Example AA6, the subject matter of any one of Examples AA1-AA5 can optionally include where the communication path using the service provider's core infrastructure is maintained when the direct radio interface path is established.

In Example AA7, the subject matter of any one of Examples AA1-AA6 can optionally include where the request that the direct radio interface path be established is communicated to a service provider control node associated with the service provider.

In Example AA8, the subject matter of any one of Examples AA1-AA9 can optionally include where a user equipment associated with the base station requests the direct radio interface path be established and the request is communicated to a service provider control node from the base station

In Example AA9, the subject matter of any one of Examples AA1-AA8 can optionally include where the data center includes at least one server.

Example X1 is a machine-readable storage medium including machine-readable instructions to implement a method or realize an apparatus as in any one of the Examples A1-A5, AA1-AA9, or M1-M6. Example Y1 is an apparatus comprising means for performing any of the Example methods M1-M6. In Example Y2, the subject matter of Example Y1 can optionally include the means for performing the method comprising a processor and a memory. In Example Y3, the subject matter of Example Y2 can optionally include the memory comprising machine-readable instructions.

What is claimed is:

1. At least one machine readable medium comprising one or more instructions that, when executed by at least one processor, cause the at least one processor to:
establish a communication path using a service provider's core infrastructure between a base station and a data center, wherein the service provider's core infrastructure includes one or more servicing gateways and one or more packet data network gateways;
request a direct radio interface path be established as a new communication path between the base station and the data center; and
establish the direct radio interface path between the base station and the data center, wherein the direct radio interface path bypasses the service provider's core infrastructure.

2. The at least one machine readable medium of claim 1, wherein the service provider's core infrastructure is part of a 3rd Generation Partnership Project (3GPP) network.

3. The at least one machine readable medium of claim 2, wherein the bypassed service provider's core infrastructure includes 3GPP architecture above a Layer 2 media access control sub-layer.

4. The at least one machine readable medium of claim 1, wherein the direct radio interface path to the data center is at a Layer 2 network level.

5. The at least one machine readable medium of claim 1, wherein a media access control layer remains unchanged when the direct radio interface path is established.

6. The at least one machine readable medium of claim 5, wherein the communication path using the service provider's core infrastructure is maintained when the direct radio interface path is established.

7. The at least one machine readable medium of claim 1, wherein the request that the direct radio interface path be established is communicated to a service provider control node associated with the service provider.

8. The at least one machine readable medium of claim 1, wherein a user equipment associated with the base station requests the direct radio interface path be established and the request is communicated to a service provider control node from the base station.

9. A server in a data center comprising:
memory;
a data center interface engine; and
at least one processor, wherein the data center interface engine is configured to cause the at least one processor to:
communicate on a communication path using a service provider's core infrastructure between a base station and the data center, wherein the service provider's core infrastructure includes one or more servicing gateways and one or more packet data network gateways;
request a direct radio interface path be established as a new communication path between the base station and the data center; and
establish the direct radio interface path between the base station and the data center, wherein the direct radio interface path bypasses the service provider's core infrastructure.

10. The server of claim 9, wherein the service provider's core infrastructure is part of a 3rd Generation Partnership Project (3GPP) network.

11. The server of claim 10, wherein the bypassed service provider's core infrastructure includes 3GPP architecture above a Layer 2 media access control sub-layer.

12. The server of claim 9, wherein the direct radio interface path to the data center is at a Layer 2 network level.

13. The server of claim 9, wherein a media access control layer remains unchanged when the direct radio interface path is established.

14. A method comprising:
establishing a communication path using a service provider's core infrastructure between a base station and at least one server, wherein the service provider's core infrastructure includes one or more servicing gateways and one or more packet data network gateways;
requesting a direct radio interface path be established as a new communication path between the base station and the at least one server; and
establishing the direct radio interface path between the base station and the at least one server, wherein the direct radio interface path bypasses the service provider's core infrastructure.

15. The method of claim 14, wherein the service provider's core infrastructure is part of a 3rd Generation Partnership Project (3GPP) network.

16. The method of claim 15, wherein the bypassed service provider's core infrastructure includes 3GPP architecture above a Layer 2 media access control sub-layer.

17. The method of claim 14, wherein the direct radio interface path to the at least one server is at a Layer 2 network level.

18. The method of claim 14, wherein a media access control layer remains unchanged when the direct radio interface path is established.

19. The method of claim 18, wherein the communication path using the service provider's core infrastructure is maintained when the direct radio interface path is established.

20. A system for establishing a direct radio interface connection, the system comprising:
memory;
one or more processors;
means for establishing a communication path using a service provider's core infrastructure between a base station and at least one server, wherein the service provider's core infrastructure includes one or more servicing gateways and one or more packet data network gateways;
means for requesting a direct radio interface path be established as a new communication path between the base station and the at least one server; and
means for establishing the direct radio interface path between the base station and the at least one server, wherein the direct radio interface path bypasses the service provider's core infrastructure.

21. The system of claim 20, wherein the service provider's core infrastructure is part of a 3rd Generation Partnership Project (3GPP) network.

22. The system of claim 21, wherein the bypassed service provider's core infrastructure includes 3GPP architecture above a Layer 2 media access control sub-layer.

23. The system of claim 20, wherein the direct radio interface path to the at least one server is at a Layer 2 network level.

24. The system of claim 20, wherein a media access control layer remains unchanged when the direct radio interface path is established.

25. The system of claim 20, wherein the communication path using the service provider's core infrastructure is maintained when the direct radio interface path is established.
